(19) United States
(12) Patent Application Publication
(10) Pub. No.: US 2020/0308903 A1
(43) Pub. Date: Oct. 1, 2020

(54) Apparatus, System and Method for Delivery of an Item

(71) Applicant: Package Hatch LLC, Mount Juliet, TN (US)

(72) Inventor: Carrie Anderson, Franklin, TN (US)

(21) Appl. No.: 16/745,410

(22) Filed: Jan. 17, 2020

Related U.S. Application Data
(60) Provisional application No. 62/826,022, filed on Mar. 29, 2019.

(51) Int. Cl. E06B 7/32; E05F 15/76; E06B 7/28; E05F 15/73; E05F 15/77; A47G 29/14

(52) U.S. Cl. CPC E06B 7/32; E05F 15/76; E06B 7/28; E05F 15/73; A47G 2029/149; A47G 29/141; E05Y 2900/132; A47G 2029/145; E05F 15/77

(57) ABSTRACT

A system for receiving delivery of an item includes: a door including at least one passage formed therethrough; a hatch movably located on the door and arranged at least partially over the passage formed through the door; an actuator coupled with the hatch for moving the hatch between an open position and a closed position; a controller in electronic communication with the actuator; and a sensor in communication with the controller. When the sensor detects a delivery of the item, the controller activates the actuator to move the hatch to the open position to allow the item to be inserted through the passage formed through the door.

### CROSS-REFERENCE TO RELATED APPLICATION

This application claims priority to and is a non-provisional of U.S. Provisional Patent Application Ser. No. 62/826,022 for “Apparatuses, Systems, and Methods for Providing Delivery” filed on Mar. 29, 2019, the contents of which are hereby incorporated by reference in its entirety.

### FIELD

The present disclosure relates generally to apparatuses, systems, and methods for providing delivery.

### BACKGROUND

Delivery services play a large role in modern life. No matter how diligent a delivery service might be in dropping off an item, a thief is capable of stealing the item unless the item is first received by a recipient or the item is placed in a secured facility or other secure manner. For example, apartment buildings might have a person designated with receiving and securing delivered items and properly distributing the same to a recipient. However, difficulties arise, for example, with single family homes, which are unlikely to have a designated individual to securely store and retrieve packages for a recipient. A group of individuals referred to as “porch pirates” are known to seek out unsecured delivery items and to steal those delivery items before a recipient is able to retrieve the items. Oftentimes, a homeowner might request a delivery service to place any delivered items at a particular location of a residence or may request that the delivery items be held by the delivery service for secured pickup at a facility of the delivery service to avoid the threat of porch pirates.

Accordingly, what is needed is a way to securely receive delivered items without requiring the overhead of employing a designated individual or requiring a delivery service to secure a delivered item until the recipient is capable of receiving the item.

### SUMMARY

Embodiments of the present disclosure provide apparatuses, systems, and methods for providing delivery.

Implementations consistent with the present disclosure may permit a delivery person to securely deliver one or more items using a controllable hatch which is configured to open and close according to at least one signal received at a sensor of the delivery system.

Numerous other objects, features, and advantages of the present disclosure will be readily apparent to those skilled in the art upon a reading of the following disclosure when taken in conjunction with the accompanying drawings.

In a first aspect, a system for receiving delivery of an item includes: a door including at least one passage formed therethrough; a hatch movably located on the door and arranged at least partially over the passage formed through the door; an actuator coupled with the hatch for moving the hatch between an open position and a closed position; a controller in electronic communication with the actuator; and a sensor in communication with the controller. When the sensor detects a delivery of the item, the controller activates the actuator to move the hatch to the open position to allow the item to be inserted through the passage formed through the door.

In one embodiment, the system for delivery of an item includes a wireless communications module in communication with the controller. In another embodiment, detection of the delivery of the item is based on detection of a fob in proximity to the sensor.

In yet another embodiment, the sensor is located on an outer surface of the hatch. In one embodiment, the sensor is located on a wall in proximity to the door.

In another embodiment, when the delivery of the item is detected by the sensor, at least one dimension of the item is received on the controller such that the actuator moves the open position of the hatch corresponds to a size of the item.

In yet another embodiment, the hatch slides with respect to the door. In one embodiment, the hatch is mounted on a hatch frame within the door.

In another embodiment, the hatch is at least partially located within a cavity of the door when the hatch is in the open position.

In yet another embodiment, the hatch pivots between the open position and the closed position with respect to the door.

In one embodiment, the system for delivery of an item further includes a shelf located on an inner side of the door, wherein a surface of the shelf is adjacent to the passage formed through the door. In another embodiment, the shelf further includes one or more walls formed around sides thereof.

In yet another embodiment, the controller activates the actuator to move the hatch to the open position in response to the fob being detected in proximity to the sensor. In one embodiment, the controller activates the actuator to move the hatch to the closed position within a designated period of time after moving the hatch to the open position.

In a second aspect, a system for receiving delivery of an item includes: a door including at least one passage formed therethrough; a hatch movably located on the door and arranged at least partially over the passage formed through the door; an actuator coupled with the hatch for moving the hatch between an open position and a closed position; a sensor located on the door; and a controller in electronic communication with the actuator and the sensor. When the sensor detects delivery of the item, the controller activates the actuator to move the hatch to the open position to allow the item to be inserted through the passage formed through the door. When the delivery of the item is detected by the sensor, at least one dimension of the item is received on the controller such that the actuator moves the open position of the hatch corresponds to a size of the item.

In a third aspect, a system for receiving delivery of an item includes: a door including at least one passage formed therethrough; a hatch frame located at least partially within a cavity of the door; a hatch slidably located on the door and arranged at least partially over the passage formed through the door; an actuator coupled with the hatch for moving the hatch between an open position and a closed position; a sensor located on the door; and a controller in electronic communication with the actuator and the sensor. When the sensor detects delivery of the item, the controller activates the actuator to move the hatch to the open position to allow the item to be inserted through the passage formed through the door.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1A and 1B illustrate an exemplary embodiments of an exterior-side front view of a delivery system for receiving a delivered item according to one embodiment of the present disclosure;

FIG. 2 shows an interior view of a delivery system for receiving a delivered item according to one embodiment of the present disclosure;

FIG. 3 shows a front view of a delivery system for receiving a delivered item according to one embodiment of the present disclosure;

FIG. 4 illustrates a front view of an embodiment of a delivery system for receiving a delivered item according to one embodiment of the present disclosure; and

FIG. 5 shows a cross-sectional side view of a delivery system for receiving a delivered item according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

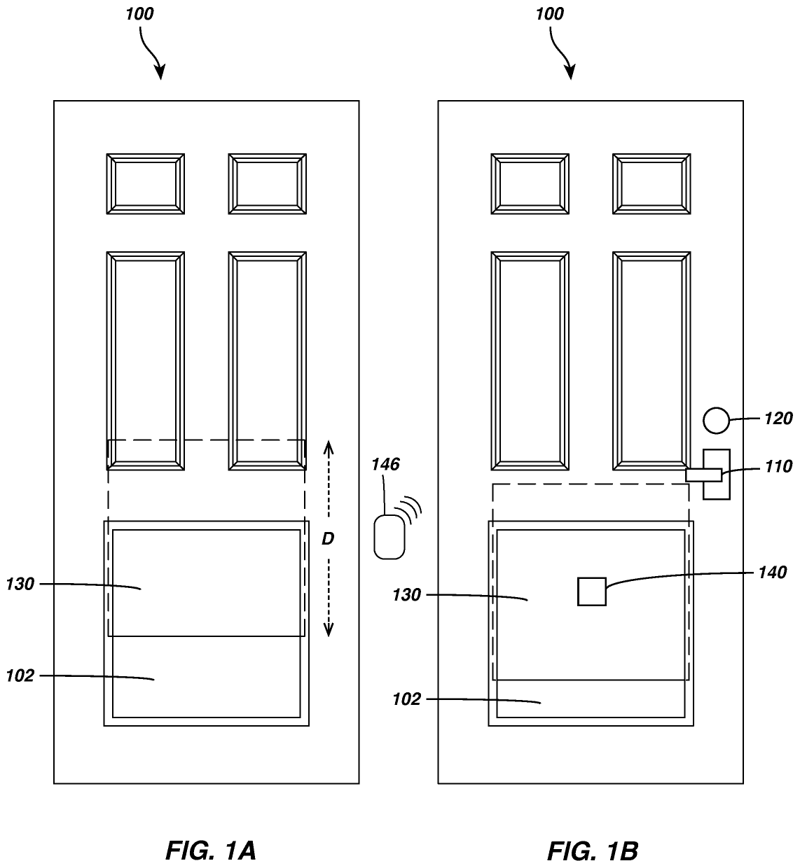

As illustrated, for example, by FIGS. 1A and 1B, an exterior-side front view of a delivery system is provided for receiving a delivered item. A door 100 may include a hatch 130 as a part of, as coupled to, and/or as otherwise associated therewith. Although illustrated herein as being a door, it should be appreciated that the door 100 is not required to be a door but may be any physical interface capable of including, coupling to, or otherwise being associated with a hatch 130 as described herein. For example, the door 100 may be, at least in part, a door, a garage door, a wall, a window, or any other surface, material, object, or interface capable of use to receive at least a portion of an item. The door 100 preferably includes a passage 102 formed therethrough over which the hatch 130 is at least partially aligned when installed on the door 100. The passage 102 is substantially concealed by the hatch 130 when the hatch 130 is in a closed position and substantially revealed by the hatch 130 when the hatch 130 is in an open position for receiving of a package through the passage 102 as described in greater detail below.

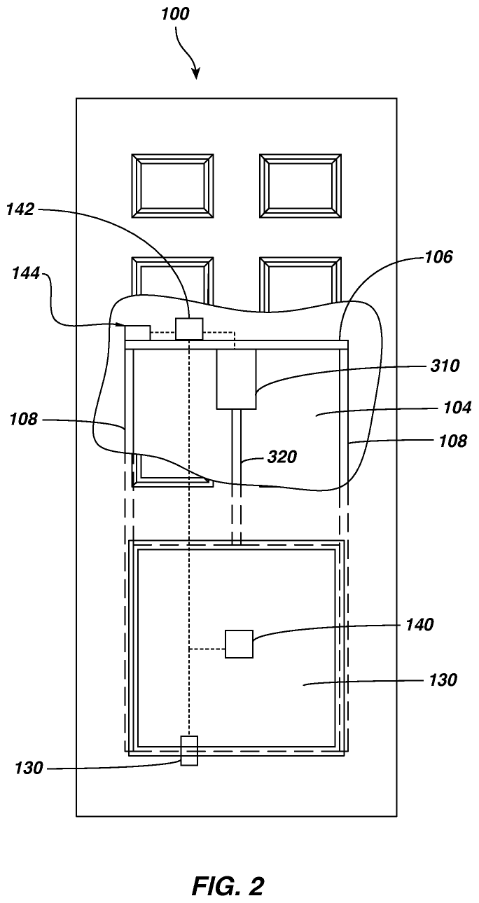

The hatch 130 may be configured to translate position in a direction D. In the embodiment illustrated by FIG. 1, the hatch 130 is configured to rise and/or fall vertically relative to the door 100. In various embodiments, the hatch 130 may be built into at least a part of the door 100. For example, a cavity 104 (FIG. 2) may be included within at least a portion of the door 100 corresponding to the hatch 130. The hatch 130 or portion thereof may be configured to be received into and/or moved out of the cavity 104 of the door 100 when moved vertically in direction D during operation. Additionally, or alternatively, the hatch 130, either in whole or in part, may be configured to correspond to the passage 102 formed through the door 100 without requiring that one or more sections of the hatch 130, in whole or in part, be received within the cavity 104 of the door 100. For example, the hatch 130 may be configured such that the hatch 130 moves vertically relative to the door 100 separate from the door 100 (e.g., by being placed at a back side thereof within a residence, the hatch 130 being configured to raise and lower behind a back surface of the door 100). While the hatch 130 is preferably described as moving vertically relative to the door 100, it is also understood that the hatch 130 may otherwise be movably associated with the door 100 such that the hatch 130 moves between open and closed positions. For example, the hatch 130 may be slidably mounted on the door 100 such that the hatch 130 moves horizontally with respect to the passage 104 formed through the door 100. In another embodiment, the hatch 130 may pivot or swing about a hinge with respect to the door 100.

The hatch 130 is mounted on a hatch frame 106. The hatch frame 106 supports the hatch 130 on the door 100, such as within the cavity 104 of the door 100. The hatch frame 106 may include opposing slides 108 for supporting the hatch 130 while allowing the hatch 130 to move between open and closed positions as described herein.

The door 100 may optionally include a handle 110 and/or deadbolt 120. The hatch 130 (and/or door 100) may include at least one sensor 140. The sensor 140 may be a proximity-based sensor in one exemplary embodiment. The sensor 140 may be configured to receive and/or transmit at least one signal corresponding to the hatch 130. The sensor 140 may be configured to receive at least one hatch position signal. The hatch position signal may be used to determine an operational position of the hatch 130. The operational position of the hatch 130 may include a closed position, a partially-open position, a fully open position, a position adjustment value, or any other position or positional information relative to the hatch 130. The sensor 140 may be configured to receive and/or transmit information to a device such as a fob or other portable or fixed-position device, such as via Bluetooth or other transmission protocols. An electronic controller 142 (FIG. 2) included with or otherwise wired or wirelessly and communicatively couplable to the sensor 140 may be configured to transmit and/or receive at least one signal associated with the hatch 130. For example, the electronic controller 142 may be configured to receive at least one signal from the sensor 140 corresponding to a signal received at the sensor 140. The electronic controller 142 may be configured to cause one or more operations to be performed based upon the at least one signal received from the sensor 140 (e.g., by causing a position of the hatch 130 to be moved relative to the door 100 in a manner described herein). A wireless communication module 144 is preferably also provided in electronic communication with the electronic controller 142 for communicating with one or more external sources over the internet via a network, such as a Wi-Fi network.

As shown in FIG. 1B, the sensor 140 may be located on a surface of the hatch 130, such as on a front-facing surface of the hatch 130 relative to the door 100. Alternatively, the sensor 140 may be located in proximity to one of the door 100 and the hatch 130. For example, the sensor 140 may be mounted on the door 100, either on a surface of the door 100 or within the cavity 104 formed within the door 100. In another alternative, the sensor 140 may be mounted proximate to the door, such as on a wall or other location in proximity to the door 100.

In various embodiments, the electronic controller 142 may be configured to confirm a delivery parameter before permitting movement of the hatch 130 during operation. For example, the electronic controller 142 may be configured to transmit a signal to a local or remote computing system or server to determine whether a received delivery signal from an external entity is a valid or proper signal. A delivery person may be provided with a fob 146 (FIGS. 1A and 1B) or other device, such as a mobile device, is communicable with the sensor 140 and selectively identifies a delivery entity, a delivery tracking number, a schedule delivery identifier, a recipient code, or any other item, delivery service, or recipient information capable of being transmitted between the fob and the sensor 140. The electronic controller 142 may then query at least one local or remote computing device to determine a status corresponding to the delivery signal. The electronic controller may then selectively operate the hatch 130 based at least in part upon the status corresponding to the delivery signal (e.g., to open the hatch, to open the hatch a specified amount according to a package size parameter, etc.). Although not illustrated, the sensor 140 and/or electronic controller may be implemented either locally or remotely relative to the door 100. For example, one or more operations corresponding to the sensor 140 and/or electronic controller may be performed by the sensor 140 and/or electronic controller 142, may be performed by at least one element associated with the sensor 140 and/or electronic controller 142 remote from the door 100, or any combination thereof.

In one illustrative example, when a package is to be delivered, the fob 146 is detected by the sensor 140 of the door 100. When the sensor 140 detects presence of the fob 146, such as by the fob 146 being in proximity to the door 100, information from the fob 146 is evaluated to determine whether the hatch 130 should be opened and other parameters related to opening of the hatch 130. For example, detection of the fob 146 may include a tracking number or other identifier associated with the fob 146. If the tracking number or other identifier is confirmed to be associated with a location of the door 100, the electronic controller 142 may activate opening of the hatch 130. Further, when the tracking number or other identifier is recognized, data associated with the tracking number or other identifier of a package is retrieved for opening of the hatch 130. For example, dimensions of a package or other item may be associated with the tracking number or other identifier. The electronic controller 142 may partially open the hatch 130 in an amount corresponding to a size of the package such that the package may be placed through the passage 102 without fully opening the hatch 130.

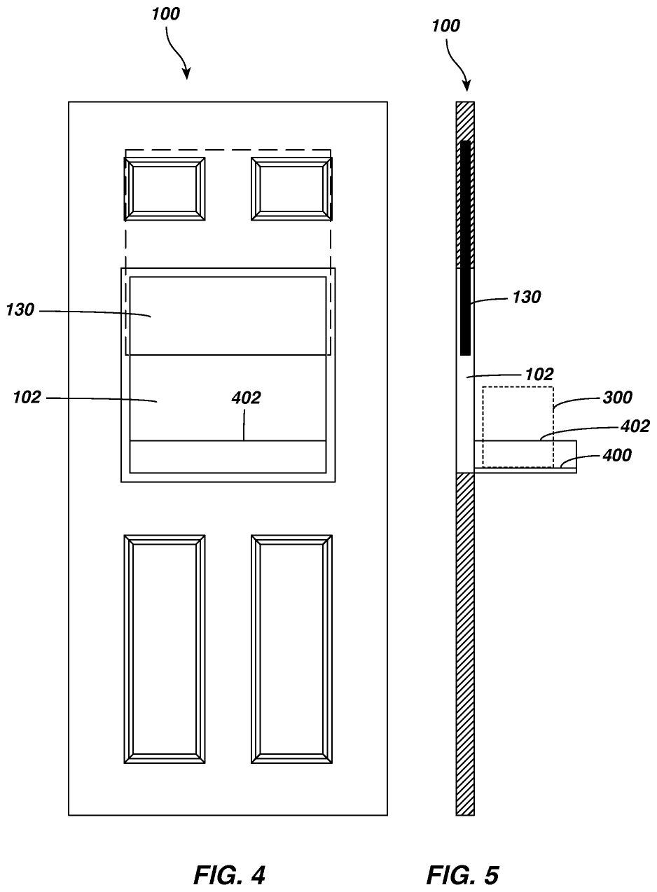

FIG. 2 illustrates an exemplary embodiment of an interior mechanical view of a door according to aspects of the present disclosure. One or more elements illustrated by FIG. 4 may be contained or containable within at least a portion of the door 100 in various embodiments. The door 100 may optionally include one or more actuators 310, such as hydraulic arms, coupled to an arm 320. Although described with reference to actuators, it should be appreciated that one or more actuators 310 may be any device or element capable of causing movement of the arm 320 and/or the hatch 130 (e.g., optionally in the direction D and/or opposite direction) without departing from the spirit and scope of the present disclosure. In an exemplary embodiment, one end of the arm 320 is coupled to or couplable with a hydraulic arm 310. An opposing end of the arm 320 may be coupled to or couplable with the hatch 130. Although illustrated as being directly coupled to each of the hydraulic arm 130 and the hatch 130, it should be appreciated that one or more non-illustrated elements such as an adapter, translation mechanism, or any other element may be coupled between the arm 320 and at least one hydraulic arm and/or hatch 130. At least one of the one or more actuators 310 may be configured to perform at least one operation based at least in part upon a signal received at the sensor 140. In one exemplary embodiment, movement of the hatch 130 by the at least one hydraulic arm 310 is configured to be controlled by the electronic controller according to at least one signal received at the sensor 140.

The hatch 130 is further couplable to at least one hatch lock 330, operable in a locked or unlocked configuration, coupled to or couplable between the hatch 130 and the door 100, such as to the hatch frame 106. The hatch lock 330 may be configured to prevent movement of the hatch 130 when in a locked position. A locked or unlocked status and position of the hatch lock 330 may be controlled, in whole or in part, by the electronic controller 142. Additionally, or alternatively, the door 100 may include a manual locking mode capable of permitting an individual at the enclosure to prevent opening of the hatch 130. Optionally, the door 100 may be configured to selectively permit operation of the hatch 130 when the hatch lock 330 is in a locked configuration, for example according to manual or automatic control.

In various exemplary embodiments, a hatch lock 330 may be maintained in a locked configuration unless and until a valid open signal is received at the sensor 140. For example, a valid delivery signal may be received at the sensor 140, at which time the electronic controller 142 causes the hatch 130 to open to accept delivery of a delivery item (e.g., delivery item 300). After a delivery item is received (e.g., either responsive to a delay period, a detected package received signal, or delivery person or recipient item delivered signal), the electronic controller 142 may cause the hatch 130 to close using at least one hydraulic arm 310, and may further cause at least one hatch lock 330 to enter a locked position.

The door 100 may include the one or more actuators 310 configured to actuate movement of the hatch 130. The arm 320 may be coupled to the hatch 130 at in interior portion thereof, may be coupled to an exterior surface thereto, or a combination thereof, including one or more additional components, without departing from the spirit and scope of the present disclosure. In various embodiments, a bottom portion of the frame 106 may be configured to provide a mechanical stop associated with a closed position of the hatch 130 relative to the door 100.

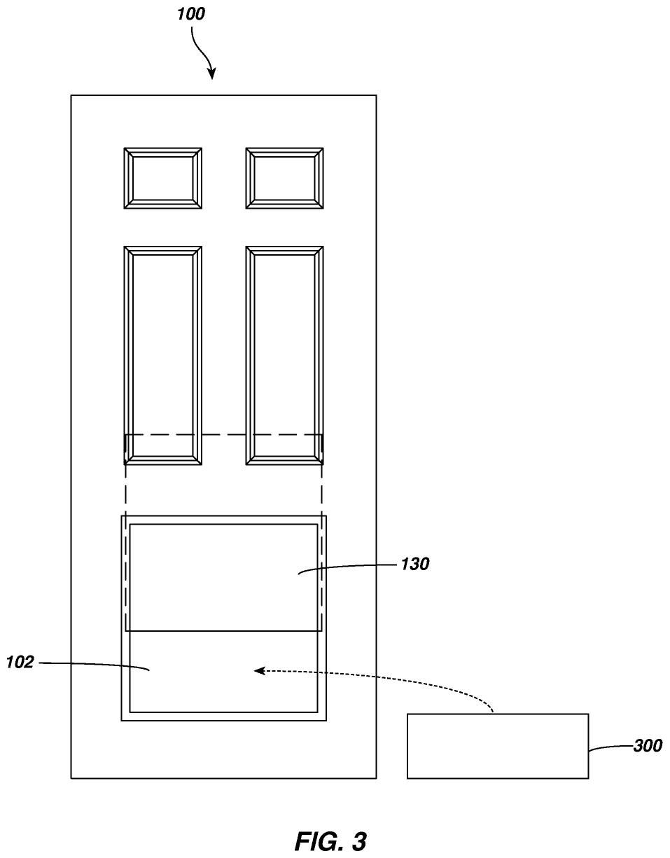

FIG. 3 illustrates an exemplary embodiment of a front view of the door 100 with the hatch 130 at least partially opened for receiving an item 300 therethrough. The hatch 130 is opened such that the item 300 may fit through the passage 102 of the door 100 as revealed by the hatch 130 in an at least partially opened position.

FIGS. 4 and 5 illustrate an embodiment of the door 100 providing accessibility for a recipient of the item 300 through the passage 102 formed through the door 100. As shown in FIGS. 5 and 6, an optional shelf 400 is located on an inner side of the door 100 adjacent the passage 102 such that when an item is placed through the passage 102 when the hatch 130 is in an at least partially open position the item 300 is supported on the shelf 400. The shelf 400 preferably includes sides 402 formed around an edge thereof to prevent the item 300 from falling off of the shelf 400, such as during opening and closing of the door 100. As shown in FIGS. 5 and 6, the passage 102 and the shelf 400 located in proximity thereto are preferably located on an upper half of the door 100 to facilitate retrieval of the item 300 without requiring a user to pick the item 300 up off of the ground or floor.

Embodiments of the door 100 described herein advantageously enable delivery of an item to a desired location, such as a residence, without requiring that an occupant of the residence open the door for delivery. Further, delivery of an item may be made without requiring an occupant to open the door or a hatch located through the door. Delivery may be made such that the hatch is automatically opened in response to delivery of a package being detected. Embodiments of the door described herein reduce the likelihood of theft of a delivery by allowing placement of the item through the door and further alleviate the need for an occupant to be home to receive a delivery item.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A system for receiving delivery of an item comprising:
a door including at least one passage formed therethrough;
a hatch movably located on the door and arranged at least partially over the passage formed through the door;
an actuator coupled with the hatch for moving the hatch between an open position and a closed position;
a controller in electronic communication with the actuator; and
a sensor in communication with the controller;
wherein when the sensor detects a delivery of the item, the controller activates the actuator to move the hatch to the open position to allow the item to be inserted through the passage formed through the door.

2. The system for delivery of an item of claim 1, further comprising a wireless communications module in communication with the controller.

3. The system for delivery of an item of claim 1, wherein detection of the delivery of the item is based on detection of a fob in proximity to the sensor.

4. The system for delivery of an item of claim 1, wherein the sensor is located on an outer surface of the hatch.

5. The system for delivery of an item of claim 1, wherein the sensor is located on a wall in proximity to the door.

6. The system for delivery of an item of claim 1, wherein when the delivery of the item is detected by the sensor, at least one dimension of the item is received on the controller such that the actuator moves the open position of the hatch corresponds to a size of the item.

7. The system for delivery of an item of claim 1, wherein the hatch slides with respect to the door.

8. The system for delivery of an item of claim 7, wherein the hatch is mounted on a hatch frame within the door.

9. The system for delivery of an item of claim 7, wherein the hatch is at least partially located within a cavity of the door when the hatch is in the open position.

10. The system for delivery of an item of claim 1, wherein the hatch pivots between the open position and the closed position with respect to the door.

11. The system for delivery of an item of claim 1, further comprising a shelf located on an inner side of the door, wherein a surface of the shelf is adjacent to the passage formed through the door.

12. The system for delivery of an item of claim 11, the shelf further comprising one or more walls formed around sides thereof.

13. The system for delivery of an item of claim 3, wherein the controller activates the actuator to move the hatch to the open position in response to the fob being detected in proximity to the sensor.

14. The system for delivery of an item of claim 13, wherein the controller activates the actuator to move the hatch to the closed position within a designated period of time after moving the hatch to the open position.

15. A system for receiving delivery of an item comprising:
a door including at least one passage formed therethrough;
a hatch movably located on the door and arranged at least partially over the passage formed through the door;
an actuator coupled with the hatch for moving the hatch between an open position and a closed position;
a sensor located on the door; and
a controller in electronic communication with the actuator and the sensor;
wherein when the sensor detects delivery of the item, the controller activates the actuator to move the hatch to the open position to allow the item to be inserted through the passage formed through the door; and
wherein when the delivery of the item is detected by the sensor, at least one dimension of the item is received on the controller such that the actuator moves the open position of the hatch corresponds to a size of the item.

16. A system for receiving delivery of an item comprising:
a door including at least one passage formed therethrough;
a hatch frame located at least partially within a cavity of the door;
a hatch slidably located on the door and arranged at least partially over the passage formed through the door;
an actuator coupled with the hatch for moving the hatch between an open position and a closed position;
a sensor located on the door; and
a controller in electronic communication with the actuator and the sensor;
wherein when the sensor detects delivery of the item, the controller activates the actuator to move the hatch to the open position to allow the item to be inserted through the passage formed through the door.
